(19) United States
(12) Patent Application Publication
(10) Pub. No.: US 2025/0380159 A1
(43) Pub. Date: Dec. 11, 2025

(54) INITIATION OF CHANNEL INFORMATION ACQUISITION PROCEDURE IN A D-MIMO NETWORK

(71) Applicant: Telefonaktiebolaget LM Ericsson (publ), Stockholm (SE)

(72) Inventors: Pål FRENGER, Linköping (SE); Joao VIEIRA, Hjärup (SE); Erik G. LARSSON, Linköping (SE); Ke WANG HELMERSSON, Linköping (SE)

(21) Appl. No.: 19/127,817

(22) PCT Filed: Nov. 8, 2022
(86) PCT No.: PCT/SE2022/051037

§ 371 Date: May 7, 2025

(51) Int. Cl. H04W 24/02; H04B 7/0413

(52) U.S. Cl. CPC H04W 24/02; H04B 7/0413

(57) ABSTRACT

There is provided techniques for initiating a channel information acquisition procedure in a D-MIMO network. A method is performed by a centralized node in the D-MIMO network. The method comprises calculating an AP based utility score for the APs to initiate the channel information acquisition procedure. The method comprises calculating a UE based utility score for the UEs to initiate the channel information acquisition procedure. The method comprises selecting, for initiating the channel information acquisition procedure, the APs or the UEs, depending on which of the utility scores is highest.

The project leading to this application has received funding from the European Union's Horizon 2020 research and innovation programme under grant agreement No 101013425.

### TECHNICAL FIELD

Embodiments presented herein relate to methods, a centralized node, a user equipment, computer programs, and a computer program product for initiating a channel information acquisition procedure in a distributed multiple input multiple output network.

### BACKGROUND

Multi-antenna techniques can significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO systems, or just MIMO for short.

Distributed MIMO (D-MIMO, also referred to as cell-free massive MIMO, RadioStripes, RadioWeaves, and ubiquitous MIMO) is a candidate technology component for the physical layer of the 6^{th} generation (6G) telecommunication system. D-MIMO is based on geographically distributing the antennas of the network and configure them to operate phase-coherently together. Deployments of D-MIMO networks may be used to provide good coverage and high capacity for areas with high traffic requirements such as factory buildings, stadiums, office spaces and airports, just to mention a few examples.

In a typical architecture, multiple access points (APs) are interconnected and configured such that two or more APs can cooperate in coherent decoding of data from a given user equipment (UE) served by the network, and such that two or more APs can cooperate in coherent transmission of data to a UE. The APs might thus collectively define the access part of the D-MIMO network. Each AP has one or more antenna panel. Each antenna panel might comprise multiple antenna elements that are configured to operate phase-coherently together.

For robust, high throughput, communication, the preferred way of D-MIMO operation is in time-division duplexing (TDD), relying on reciprocity of the propagation channel between the serving APs and the served UE. Pilot signals transmitted by the UEs can thereby be used for the APs to simultaneously obtain the uplink channel response (i.e., the channel response for the radio channel from the UEs towards the APs) and the downlink channel response (i.e., the channel response for the radio channel from the APs towards the UEs). This type of TDD operation especially facilitates reciprocity-based beamforming in the downlink.

As will be explained next, there are several fundamental differences between a traditional cellular MIMO network and a D-MIMO network.

In FIG. 1 is schematically illustrated a traditional cellular MIMO network 10 comprising two APs 110, each serving its own cell 20. A plurality of UEs 300 are served by each AP, and thus in each cell. As can be seen from FIG. 1, the APs are surrounded by the UEs; the number of UEs are orders of magnitude higher than the number of APs. Further, the number of antenna elements per AP is generally higher than the number of antenna elements per UE, for example up to 64 antenna elements per AP but only 1-4 antenna elements per UE. All APs are participating the transmission of system information, cell-defining reference signals, paging signals, etc. even if there are no ongoing data transmissions.

In FIG. 2 is schematically illustrated a D-MIMO network 100 comprising APs 110, each serving its own cell. The APs 110 are controlled by a centralized controller 200. Only the cells served by four of the APs are illustrated. Further, it could be that, at a given point in time, only a subset of the APs 110 is active whereas the remaining APs are inactive. Each AP 110 serves one or more UEs 300, but given that the number of UEs 300s is the same as in FIG. 1, there are fewer UEs 300 served by each AP 110 in the D-MIMO network 100 than in the traditional cellular MIMO network in FIG. 1. As can be seen from FIG. 1, the UEs are surrounded by APs; the number of UEs and APs may be of the same order of magnitude. Further, the number of antenna elements per AP is generally the same as, or at least very similar to, the number of antenna elements per UE. For example, the number of antenna elements per AP and UE may be in the range between 1 and 8. APs in a D-MIMO network should be small and have low cost and that typically implies that APs in a D-MIMO network cannot have as many antenna elements as in a traditional cellular MIMO network. The active APs are constantly transmitting idle mode broadcast signals (performing e.g., beam sweeping, system information broadcast, etc.) in idle mode, and the inactive APs are only active during user plane data transmission and/or reception. Since the APs are more densely deployed in the D-MIMO network than in the traditional cellular MIMO network, only a subset of the APs is needed for transmitting system information, cell-defining reference signals, paging signals, etc. This implies that UEs cannot always obtain channel state information related to the actual one or more APs serving the UE in active mode by listening to broadcast signals related to idle mode transmissions. This also implies that most APs are only active during data transmission (in order to ensure multi-user communications with high spectral efficiency).

It is here noted that schemes exist for supporting multi-transmission point (mTRP) systems. In an mTRP system, the UE can receive data transmission from multiple beams at the same time. These beams may belong to the same cell or to different cells. System information, cell-defining reference signals, paging signals, etc. are defined as always-on signals. Hence this setup resembles the scenario in FIG. 1. Even though there are multiple TRPs in a mTRP system, the acquisition of channel information therefore still functions as in a traditional cellular MIMO network. Based on the above-noted differences between a traditional cellular MIMO network and a D-MIMO network, these types of schemes do not scale well to the fundamentally different D-MIMO network in FIG. 2.

Hence, there is a need for efficient channel information acquisition in D-MIMO networks.

### SUMMARY

An object of embodiments herein is to provide channel information acquisition procedures suitable for a D-MIMO network.

According to a first aspect there is presented a method for initiating a channel information acquisition procedure in a D-MIMO network. The channel information acquisition procedure is initiated by transmission of pilot signals in the D-MIMO network. The D-MIMO network comprises APs serving UEs. The method is performed by a centralized node in the D-MIMO network. The method comprises calculating an AP based utility score for the APs to initiate the channel information acquisition procedure. The AP based utility score pertains to an estimated network improvement and an estimated network resource cost if the channel information acquisition procedure is initiated by the APs. The method comprises calculating a UE based utility score for the UEs to initiate the channel information acquisition procedure. The UE based utility score pertains to an estimated network improvement and an estimated network resource cost if the channel information acquisition procedure is initiated by the UEs. The method comprises selecting, for initiating the channel information acquisition procedure, the APs when the AP based utility score is highest, and the UEs when the UE based utility score is highest. The method comprises informing the APs and the UEs of which of the APs and the UEs to initiate the channel information acquisition procedure.

According to a second aspect there is presented a centralized node for initiating a channel information acquisition procedure in a D-MIMO network. The channel information acquisition procedure is initiated by transmission of pilot signals in the D-MIMO network. The D-MIMO network comprises APs serving UEs. The centralized node comprises processing circuitry. The processing circuitry is configured to cause the centralized node to calculate an AP based utility score for the APs to initiate the channel information acquisition procedure. The AP based utility score pertains to an estimated network improvement and an estimated network resource cost if the channel information acquisition procedure is initiated by the APs. The processing circuitry is configured to cause the centralized node to calculate a UE based utility score for the UEs to initiate the channel information acquisition procedure. The UE based utility score pertains to an estimated network improvement and an estimated network resource cost if the channel information acquisition procedure is initiated by the UEs. The processing circuitry is configured to cause the centralized node to select, for initiating the channel information acquisition procedure, the APs when the AP based utility score is highest, and the UEs when the UE based utility score is highest. The processing circuitry is configured to cause the centralized node to inform the APs and the UEs of which of the APs and the UEs to initiate the channel information acquisition procedure.

According to a third aspect there is presented a centralized node for initiating a channel information acquisition procedure in a D-MIMO network. The channel information acquisition procedure is initiated by transmission of pilot signals in the D-MIMO network. The D-MIMO network comprises APs serving UEs. The centralized node comprises a calculate module configured to calculate an AP based utility score for the APs to initiate the channel information acquisition procedure. The AP based utility score pertains to an estimated network improvement and an estimated network resource cost if the channel information acquisition procedure is initiated by the APs. The centralized node comprises a calculate module configured to calculate a UE based utility score for the UEs to initiate the channel information acquisition procedure. The UE based utility score pertains to an estimated network improvement and an estimated network resource cost if the channel information acquisition procedure is initiated by the UEs. The centralized node comprises a select module configured to select, for initiating the channel information acquisition procedure, the APs when the AP based utility score is highest, and the UEs when the UE based utility score is highest. The centralized node comprises an inform module configured to inform the APs and the UEs of which of the APs and the UEs to initiate the channel information acquisition procedure.

According to a fourth aspect there is presented a computer program for initiating a channel information acquisition procedure in a D-MIMO network, the computer program comprising computer program code which, when run on processing circuitry of a centralized node of the D-MIMO network, causes the centralized node to perform a method according to the first aspect.

According to a fifth aspect there is presented a method for initiating a channel information acquisition procedure in a D-MIMO network. The channel information acquisition procedure is initiated by transmission of pilot signals in the D-MIMO network. The D-MIMO network comprises APs serving UEs. The method is performed by one of the UEs. The method comprises obtaining, from a centralized node in the D-MIMO network, information of whether the channel information acquisition procedure is to be initiated in downlink or uplink. The method comprises transmitting the pilot signals when the channel information acquisition procedure is to be initiated on the uplink. The method comprises receiving the pilot signals from at least some of the APs when the channel information acquisition procedure is to be initiated on the downlink.

According to a sixth aspect there is presented a UE, for initiating a channel information acquisition procedure in a D-MIMO network. The channel information acquisition procedure is initiated by transmission of pilot signals in the D-MIMO network. The D-MIMO network comprises APs serving UEs. The UE comprises processing circuitry. The processing circuitry is configured to cause the UE to obtain, from a centralized node in the D-MIMO network, information of whether the channel information acquisition procedure is to be initiated in downlink or uplink. The processing circuitry is configured to cause the UE to transmit the pilot signals when the channel information acquisition procedure is to be initiated on the uplink. The processing circuitry is configured to cause the UE to receive the pilot signals from at least some of the APs when the channel information acquisition procedure is to be initiated on the downlink.

According to a seventh aspect there is presented a UE, for initiating a channel information acquisition procedure in a D-MIMO network. The channel information acquisition procedure is initiated by transmission of pilot signals in the D-MIMO network. The D-MIMO network comprises APs serving UEs. The UE comprises an obtain module configured to obtain, from a centralized node in the D-MIMO network, information of whether the channel information acquisition procedure is to be initiated in downlink or uplink. The UE comprises a transmit module configured to transmit the pilot signals when the channel information acquisition procedure is to be initiated on the uplink. The UE comprises a receive module configured to receive the pilot signals from at least some of the APs when the channel information acquisition procedure is to be initiated on the downlink.

According to an eighth aspect there is presented a computer program for initiating a channel information acquisition procedure in a D-MIMO network, the computer program comprising computer program code which, when run on processing circuitry of a UE, causes the UE to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide efficient channel information acquisition in a D-MIMO network.

Advantageously, these aspects enable increased system capacity in the D-MIMO network, due to avoiding resource expensive uplink/downlink pilot transmissions when uplink/downlink capacity is a bottleneck.

Advantageously, these aspects enable improved user experience, due to reduced interference and overhead cost related to the pilot transmissions.

Advantageously, these aspects enable reduced latency for prioritized and latency sensitive services.

Advantageously, these aspects enable reduced network energy consumption and operational cost.

Advantageously, these aspects enable APs to spend longer time in idle mode. In turn, this enables smaller and/or cheaper thermal management solutions.

Other objectives, features and advantages of the enclosed embodiments will be apparent from the following detailed disclosure, from the attached dependent claims as well as from the drawings. Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a traditional cellular MIMO network according to an example;

FIG. 2 is a schematic diagram illustrating a D-MIMO network where embodiments disclosed herein apply;

FIG. 3 is a flowchart of methods according to embodiments;

FIG. 4 is a schematic illustration of a UE initiated channel information acquisition procedure according to embodiments;

FIG. 5 is a schematic illustration of an AP initiated channel information acquisition procedure according to embodiments;

FIG. 6 is a schematic illustration of UE initiated and AP initiated channel information acquisition procedures according to embodiments;

FIG. 7 is a flowchart of methods according to embodiments;

FIG. 8 is a schematic illustration of a scenario where a channel information acquisition procedure is initiated by UEs according to embodiments;

FIG. 9 is a schematic illustration of a scenario where a channel information acquisition procedure is initiated by APs according to embodiments;

FIGS. 10 and 11 are signalling diagrams according to embodiments;

FIG. 12 is a schematic diagram showing functional units of a centralized node according to an embodiment;

FIG. 13 is a schematic diagram showing functional modules of a centralized node according to an embodiment;

FIG. 14 is a schematic diagram showing functional units of a UE according to an embodiment;

FIG. 15 is a schematic diagram showing functional modules of a UE according to an embodiment; and

FIG. 16 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above there is a need for efficient channel information acquisition in D-MIMO networks.

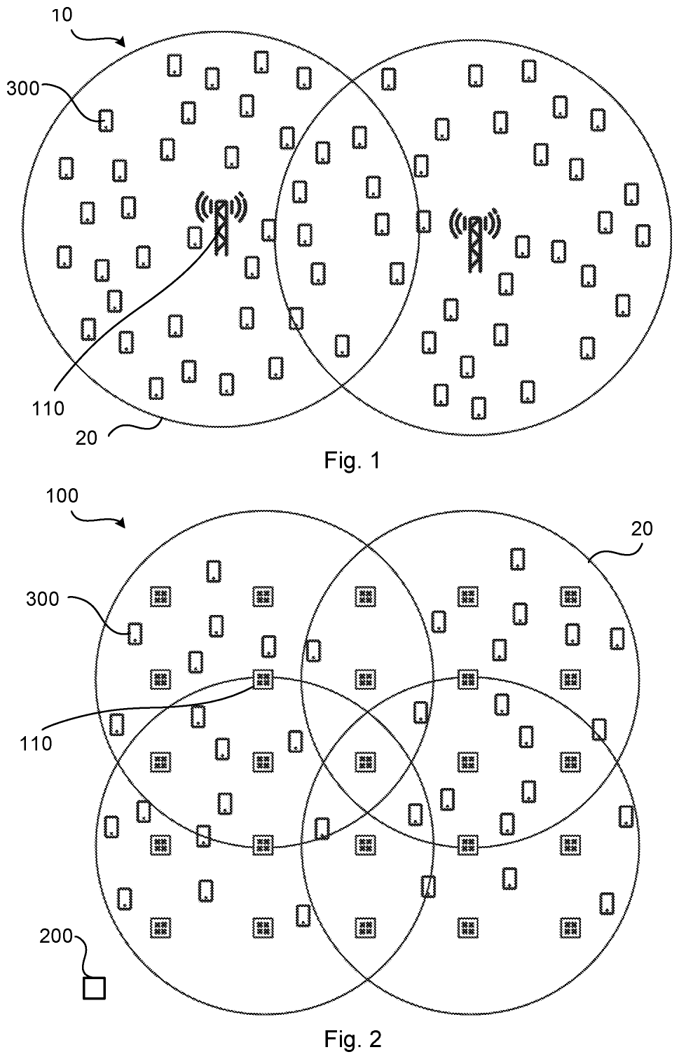

Further in this respect, several transmission schemes for traditional cellular MIMO networks rely heavily on acquiring channel state information (CSI) at the transmitting side. Schemes for CSI acquisition designed for traditional cellular MIMO networks are not well suited for D-MIMO networks, due to the differences elaborated above in relation to FIG. 1 and FIG. 2.

For example, in fifth generation (5G) new radio (NR) networks, each AP can transmit downlink reference signals in terms of synchronization signal blocks (SSBs) in up to beams. This scheme scales extremely poorly to a D-MIMO network where the number of APs may be very large and each AP may have multiple antenna elements. In a D-MIMO network, several hundred SSB transmissions might be needed if every AP is required to perform a full beam-sweep all the time. This would generate large interference in the network (causing poor performance), it would result in high network energy usage (high operational cost), and it would consume a large fraction of valuable radio resources (reducing capacity) for simple tasks such as distributing system information over the served area.

A more efficient approach (resulting in reduced interference, reduced energy consumption and higher capacity) in a D-MIMO network would be to only assign transmissions of SSBs to a sub-set of the APs. However, such a scheme might cause other issues. In 5G NR beam sweeping is always on from all APs. But in an efficiently designed D-MIMO network that would no longer be the case. This implies that the APs in a D-MIMO network not assigned to perform constant beam sweeping will only be active when there is an ongoing data service involving these APs. The UEs can therefore no longer derive information about potential active mode beams using the SSBs, as they do in 5G NR. In active mode each UE might be served by a different set of APs than what it can detect before entering active mode.

The embodiments disclosed herein therefore relate to techniques for initiating a channel information acquisition procedure in a D-MIMO network 100. In order to obtain such techniques there is provided a centralized node 200, a method performed by the centralized node 200, a computer program product comprising code, for example in the form of a computer program, that when run on processing circuitry of the centralized node 200, causes the centralized node 200 to perform the method. In order to obtain such techniques there is further provided a UE 300, a method performed by the UE 300, and a computer program product comprising code, for example in the form of a computer program, that when run on processing circuitry of the UE 300, causes the UE 300 to perform the method.

The UEs 300 might be equipped with one or more multi-antenna array panels to operate using higher frequency bands. For simplicity of the exposition of this disclosure, it is assumed that each AP 110 is fully digital in the sense that each of its transceivers is associated with one, and only one, antenna element. However, the herein disclosed concepts, methods, and devices are also applicable for APs 110 with antenna panels capable of analog beamforming or hybrid beamforming.

As an introductory remark, in D-MIMO networks 100 it is not obvious if CSI acquisition shall utilize downlink transmissions from the network side (as in 5G NR) or uplink transmissions from the UE side. There can be large differences in the resource utilization for pilot signals depending on if the pilot signals are transmitted in the downlink or in the uplink. In a typical D-MIMO network 100 the total number of UE and AP antenna elements are of the same order. Furthermore, the signalling overhead for transmission of pilot signals is using resources that could otherwise be used for data transmissions.

The herein disclosed embodiments are related to a dynamic technique for acquiring channel information that dynamically decides if the channel information acquisition procedure shall be initiated by pilot signal transmissions in the uplink (as performed by the UEs 300) or in the downlink (as performed by the APs 110). As will be further disclosed below, the decision on what channel information acquisition procedure to use depends on obtaining a utility metric. The utility metric considers parameters specifically relevant to operation of the D-MIMO network 100 (such as resource cost, latency, etc.) as will be further disclosed below.

Further, although described with reference to a D-MIMO network 100, the herein disclosed embodiments are applicable also to a traditional MIMO cellular network, for example a 5G NR network.

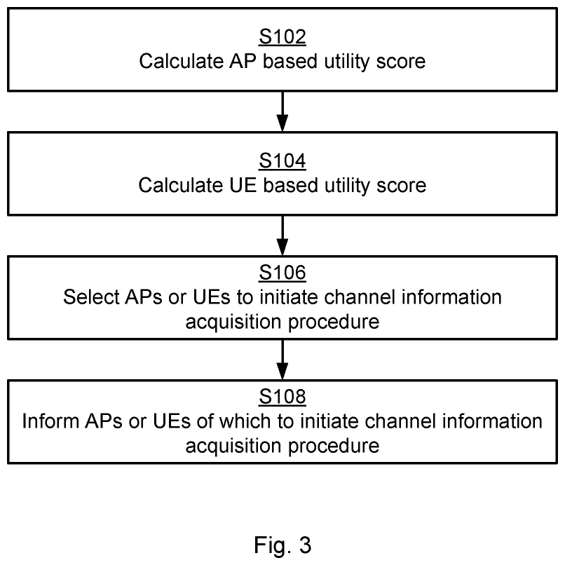

Reference is now made to FIG. 3 illustrating a method for initiating a channel information acquisition procedure in a D-MIMO network 100 as performed by the centralized node 200 according to an embodiment. The channel information acquisition procedure is initiated by transmission of pilot signals in the D-MIMO network 100. The D-MIMO network 100 comprises APs 110 serving UEs 300.
S102: The centralized node 200 calculates an AP based utility score for the APs 110 to initiate the channel information acquisition procedure. The AP based utility score pertains to an estimated network improvement and an estimated network resource cost if the channel information acquisition procedure is initiated by the APs 110.
S104: The centralized node 200 calculates a UE based utility score for the UEs 300 to initiate the channel information acquisition procedure. The UE based utility score pertains to an estimated network improvement and an estimated network resource cost if the channel information acquisition procedure is initiated by the UEs 300.
S106: The centralized node 200 selects the APs 110 for initiating the channel information acquisition procedure when the AP based utility score is highest, and selects the UEs 300 for initiating the channel information acquisition procedure when the UE based utility score is highest.
S108: The centralized node 200 informs the APs 110 and the UEs 300 of which of the APs 110 and the UEs 300 to initiate the channel information acquisition procedure.

Embodiments relating to further details of initiating a channel information acquisition procedure in a D-MIMO network 100 as performed by the centralized node 200 will now be disclosed.

There could be different examples of pilot signals. In some examples, the pilot signals as transmitted by the APs 110 are service area covering downlink reference signals, such as SSBs. In some examples, the pilot signals as transmitted by the UEs 300 are uplink reference signals, such as sounding reference signals (SRSs).

One aspect concerns how the channel information acquisition procedure affects the network resource overhead for transmission of pilots signals and the alternative use of these network resources.

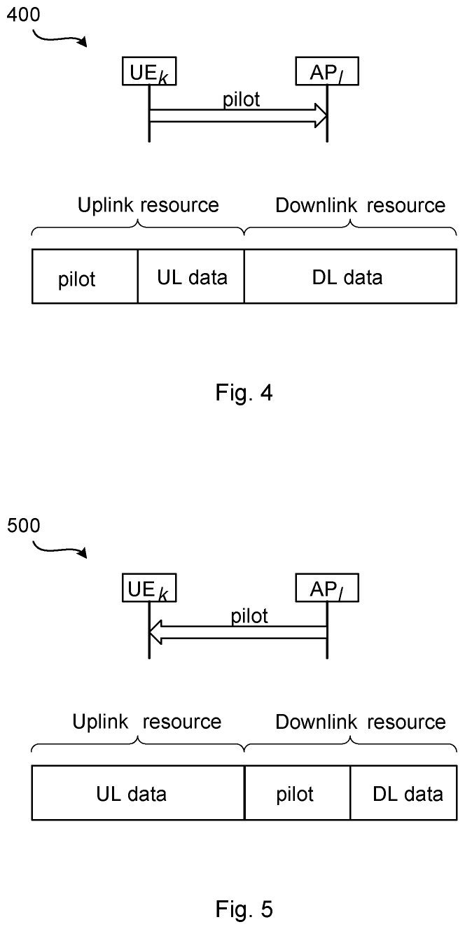

In FIG. 4 is at 400 illustrated a UE initiated channel information acquisition procedure. The term “UE initiated” refers to the case that the UEs initiate the channel information acquisition procedure by transmitting uplink pilot signals. In FIG. 4 is also illustrated the distribution of resources when the UEs transmit pilot signals. It can be seen that more resources are available for downlink data transmissions than for uplink data transmissions. In FIG. 5 is at 500 illustrated an AP initiated channel information acquisition procedure. The term “AP initiated” refers to the case that the APs initiate the channel information acquisition procedure by transmitting downlink pilot signals. In FIG. 5 is also illustrated the distribution of resources when the APs transmit pilot signals. It can be seen that more resources are available for uplink data transmissions than for downlink data transmissions.

In a TDD system with a static or semi-static allocation of UL and DL resources, pilot signals transmitted from the UEs will consume UL radio resources and pilot signals transmitted from the APs will consume DL radio resources. In that case it matters if there is an alternative concurrent use of these UL or DL resources or not.

The transmission of DL pilot signals (from the serving APs) might increase the DL interference and the transmission of UL pilot signals (from the active UES) might increase the UL interference. This increase of interference might reduce the signal to interference plus noise ratio (SINR) of ongoing data transmissions in the UL or DL, respectively. The physical resources (e.g., time and frequency resource elements) used for pilot signal transmission will also reduce the physical resources available for data transmission in the UL or DL, respectively. In particular, in some embodiments, the estimated network resource cost for the AP based utility score is dependent on amount of radio resources required for transmitting the pilot signals from the APs 110. Likewise, in some embodiments, the estimated network resource cost for the UE based utility score is dependent on amount of radio resources required for transmitting the pilot signals from the UEs 300.

The decision of selecting a “UE initiated” or an “AP initiated” channel information acquisition procedure might depend on the amount of currently ongoing UL and DL data traffic, respectively. Hence, in some embodiments, the network improvement for the AP based utility score is proportional to, and the network improvement for the UE based utility score is inversely proportional to, expected or ongoing amount of uplink data traffic. The higher the amount of uplink data traffic, the higher the AP based utility score. Likewise, in some embodiments, the network improvement for the UE based utility score is proportional to, and the network improvement for the AP based utility score is inversely proportional to, expected or ongoing amount of downlink data traffic. The higher the amount of downlink data traffic, the higher the UE based utility score. The terms proportional and inversely proportional as used throughout this disclosure do not impose any linearity.

The overhead for pilot signal transmissions also depends on the number of antenna elements in the UE and in the APs. The more antenna elements an antenna panel have, the more pilot signal resources might be required (e.g., one pilot signal sequence per antenna element).

The decision of selecting a “UE initiated” or an “AP initiated” channel information acquisition procedure might therefore consider the cost (e.g., represented by the number of antenna elements, or beam candidates, or pilot signal repetitions, etc.) of transmitting pilot signals from the UEs or the APs.

In some scenarios transmissions of pilot signals from APs might be used by more than one UE. This reduces the overhead cost since the transmission of one pilot signal in the downlink potentially can be received and measure on by many UEs.

The decision of selecting a “UE initiated” or an “AP initiated” channel information acquisition procedure might therefore depend on the number of UEs served by one and the same AP. Hence, in some embodiments, the network improvement for the AP based utility score is proportional to number of active UEs 300 being served per each of the APs 110 as averaged over a number of transmission time intervals (TTIs). The higher the number of UEs 300, the higher the AP based utility score.

In some D-MIMO scenarios the active UEs are served by a small number of APs (e.g., by just a single AP or by two or three APs). In other scenarios active UEs are served by a large number of APs (e.g., all APs deployed within a building when the UEs are located with the given building).

The decision of selecting a “UE initiated” or an “AP initiated” channel information acquisition procedure might therefore depend on the number of APs that are serving each active UE. Hence, in some embodiments, the network improvement for the UE based utility score is proportional to the number of APs 110 serving each of the active UEs 300 as averaged over a number of TTIs. The higher the number of APs 110, the higher the UE based utility score.

Furthermore, the relative cost for transmitting pilot signals from the APs versus transmitting the pilot signals from the UEs can be estimated by comparing the total number of currently active UEs (denoted N_{UE}) with the number of serving APs (denoted N_{AP}). If N_{AP}<<N_{UE}, then it is likely less costly to initiate the channel information acquisition procedure by having the serving APs transmit pilot signals. Likewise, if N_{UE}<<N_{AP}, then it is likely less costly to initiate the channel information acquisition procedure by having the active UEs transmit the pilot signals. If N_{AP}≈N_{UE}, then other considerations (e.g., latency, alternative use of radio resources, etc.) become even more important.

The decision of selecting a “UE initiated” or an “AP initiated” channel information acquisition procedure might therefore depend on the total number of currently serving APs and the total number of currently active UEs. Hence, in some embodiments, the network improvement for the AP based utility score is proportional to a total number of active UEs 300 being served by any of the APs 110. Likewise, in some embodiments, the estimated network resource cost for the UE based utility score is proportional to a total number of APs 110 serving any active UEs 300. If more UEs 300 than APs 110, then the AP based utility score is higher than the UE based utility score for this parameter.

By combining two or more of the above considerations for deciding to select a “UE initiated” or an “AP initiated” channel information acquisition procedure, the relative cost of transmitting pilot signals from the APs versus transmitting the pilot signals from the UEs can be estimated by comparing the total number of beam candidates from all serving APs (N_{AP-total}) versus the total number of beam candidates from all currently active UEs (N_{UE-total}).

The decision of selecting a “UE initiated” or an “AP initiated” channel information acquisition procedure might therefore depend on the total number of beam candidates from all serving APs and the total number of beam candidates from all currently active UEs.

Yet another aspect is the required bandwidth for UL and DL data transmissions. When a small amount of data is transmitted, a small amount of bandwidth is required, and the UEs can be frequency multiplexed. In that case, a pilot signal transmission in the reverse radio link only need to cover the bandwidth of the data transmission to occur using the acquired channel information. For example, when a small amount of UL or DL data is to be scheduled, a pilot signal with a narrow bandwidth may be used to obtain the channel information information. When the bandwidth of the pilot signal is narrow the cost of transmitting the pilot signal is smaller, and vice versa.

One aspect concerns how the channel information acquisition procedure affects latency. Latency here refers to that a data transmission (either in uplink or in downlink) is delayed.

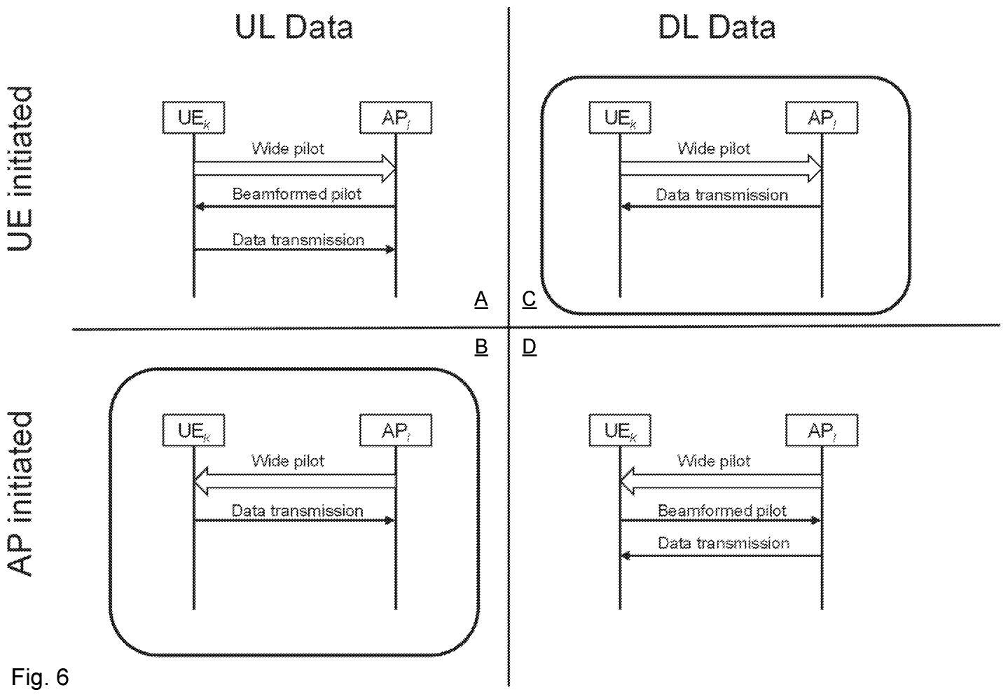

For latency sensitive (i.e., delay sensitive) services it matters if the UEs initiate the channel information acquisition procedure by transmitting a pilot signal or if the APs initiate the channel information acquisition procedure. Consider the four different examples A, B, C, and D depicted in FIG. 6. For efficient data transmission the channel information should be available at the transmitter side. In a TDD system this channel information is obtained by first having the receiver side transmitting a pilot signal in the reverse direction. Hence, in some embodiments, the network improvement for the AP based utility score is proportional to, and the network improvement for the UE based utility score is inversely proportional to a delay requirement for uplink data traffic. The stricter the delay requirement, the higher the AP based utility score. Likewise, in some embodiments, the network improvement for the UE based utility score is proportional to, and the network improvement for the AP based utility score is inversely proportional to a delay requirement for downlink data traffic. The stricter the delay requirement, the higher the UE based utility score.

Consider the case when there is data in the uplink direction, as in examples A and B. If the AP initiates the channel information acquisition procedure (as in example B) by transmitting a pilot signal, the required channel information for UL transmission is first obtained at the UE side. The UL data can then be transmitted already in step 2 in example B. If instead the UE initiates the channel information acquisition procedure by transmitting a pilot signal, then the channel information is first obtained at the AP side, as in example A. But since UL data is to be transmitted, the AP first need to transmit a second pilot signal to the UE. Only after receiving this second pilot transmission from the AP can the UE obtain channel information information for an UL MIMO transmission. The data transmission occurs in step 3 in in example A which will cause a larger latency than in example B.

Consider the case when there is data in the downlink direction, as in examples C and D. If the UE initiates the channel information acquisition procedure (as in example C) by transmitting a pilot signal, the required channel information for DL transmission is first obtained at the AP side. The DL data can then be transmitted already in step 2 in example C. If instead the AP initiates the channel information acquisition procedure by transmitting a pilot signal, then the channel information is first obtained at the UE side, as in example D. But since DL data is to be transmitted, the UE first need to transmit a second pilot signal to the AP. Only after receiving this second pilot transmission from the UE can the AP obtain channel information information for a DL MIMO transmission. The data transmission occurs in step 3 in in example D which will cause a larger latency than in example C.

The decision of selecting a “UE initiated” or an “AP initiated” channel information acquisition procedure might therefore depend on which alternative that results in the smallest data transmission latency for uplink and downlink data, respectively.

Hence, in some embodiments, the network improvement for the AP based utility score is inversely proportional to an expected data transmission delay for uplink and/or downlink data transmission if the channel information acquisition procedure is initiated for the APs 110, and the network improvement for the UE based utility score is inversely proportional to an expected data transmission delay for uplink and/or downlink data transmission if the channel information acquisition procedure is initiated for the UEs 300.

Another aspect to consider is the time it takes for the network to set up the pilot transmissions involved in UE-initiated or AP-initiated CSI acquisition process. Hence, in some embodiments, the network improvement for the AP based utility score is inversely proportional to a time duration for setting up the channel information acquisition procedure as initiated for the APs 110, and the network improvement for the UE based utility score is inversely proportional to a time duration for setting up the channel information acquisition procedure as initiated for the UEs 300.

For example, consider the case when a UE 300 is configured by the network, as represented by the centralized node 200, to transmit SRSs as uplink pilot signals. If such SRS transmissions are a-periodically triggered by the network, then the network first needs to perform a radio resource control (RRC) configuration of the UE in terms of configuring SRS signaling aspects (e.g., which time/frequency resources to use, antenna ports to use, etc.). After the RRC configuration is performed, a 1-time SRS trigger is sent in the downlink control information (DCI) of the physical downlink control channel (PDCCH). The time delay associated with the set-up of such a pilot signal transmission (i.e., both the RRC configuration as well as DCI-based triggering), as well as subsequent pilot transmissions, should be considered when deciding to initiate the channel information acquisition with a pilot signal transmission from the UEs or from the APs. Similar considerations can be made when instead a DL pilot signal transmission is to be made at the AP side.

The decision of selecting a “UE initiated” or an “AP initiated” channel information acquisition procedure might therefore depend on which alternative results in the shortest time it takes to set up such procedures, respectively.

There can be different ways to numerically calculate the AP based utility score and the UE based utility score, respectively. Below follows one non-limiting example of how these calculations can be made.

Let N_{UE} and N_{AP} be the total number of currently active UEs and serving APs, respectively. The total cost of transmitting pilot signals from the UEs and the APs can be expressed as:

$${Cost}_{UE} = α {NN}_{UE}$$

$${Cost}_{AP} = β {MN}_{AP}$$

where N and M are the number of UE and AP antenna elements, respectively, and α and β are constants indicating the relative cost of an uplink pilot signal (from the UE) and a downlink pilot signal (from the AP). One reason why the cost may differ is that there may be differences in output power as well as receiver noise between APs and UEs.

The usability of any particular pilot signal transmission may depend on how many APs or UEs that can make use of it. Let NUE,1 be the number of active UEs served by each APl, l=1, . . . , L and let NAP,k be the number of APs (NAP,k) serving each currently active UEk, k=1, . . . , K. The usability Usability_{UE-initiated} for a “UE initiated” channel information acquisition procedure and the usability Usability_{AP-initiated} for an “AP initiated” channel information acquisition procedure can then be calculated as:

$${Usability}_{UE - initiated} = {\sum }_{k = 1}^{K} {N}_{AP , k}$$

$${Usability}_{AP - initiated} = {\sum }_{l = 1}^{L} {N}_{UE , l}$$

Time delay benefits Delay_{UE-initiated} for “UE initiated” channel information acquisition procedure and the time delay benefits Delay_{AP-initiated} for an “AP initiated” channel information acquisition procedure can then be calculated as:

$${Delay}_{UE - initiated} = {f}_{1} ( D {L}_{latency reduction} ) - {f}_{2} ( U {L}_{latency reduction} )$$

$${Delay}_{AP - initiated} = {f}_{2} ( U {L}_{latency reduction} ) - {f}_{1} ( D {L}_{latency reduction} )$$

where f₁(·) and f₂(·) are some possibly non-linear functions describing the service quality impact of DL time delay and UL time delay, respectively. One example of a function that can be used here is a mean normalized and scaled function:

$$f ( x ) = \frac{α x}{\overline{x}} ,$$

where \tilde{x} is the mean value of the variable x and α is a scaling factor (e.g. α=1). Other functions are also possible.

The alternative costs, Alternative cost_{UE-initiated} and Alternative cost_{AP-initiated}, for the resources for pilot signal transmission for “UE initiated” channel information acquisition procedure and for “AP initiated” channel information acquisition procedure depend on the current amount of UL and DL data traffic. This can e.g., be expressed as:

$$Alternative {cost}_{UE - initiated} = {g}_{1} ( {N}_{UE} , U {L}_{data volume} )$$

$$Alternative {cost}_{AP - initiated} = {g}_{2} ( {N}_{AP} , D {L}_{data volume} )$$

where g₁(·) and g₂(·) are functions of the number of active UEs and APs, respectively, that would need to perform pilot signal transmissions and the amount of data that is currently required in the UL and DL respectively.

The UE based utility score (Utility_{UE-initiated}) and the AP based utility score (Utility_{AP-initiated}) can then be obtained as:

$${Utility}_{UE - initiated} = {h}_{1} ( {Cost}_{UE - initiated} , {Usability}_{UE - initiated} , {Delay}_{UE - initiated} , Alternative {cost}_{UE - initiated} )$$

$${Utility}_{AP - initiated} = {h}_{2} ( {Cost}_{AP - initiated} , {Usability}_{AP - initiated} , {Delay}_{AP - initiated} , Alternative {cost}_{AP - initiated} )$$

where h₁(·) and h₂(·) are functions (preferably linear combinations of the terms) used to combine the resource cost, the usability benefits, timed delay benefits, and the alternative cost into one single metric

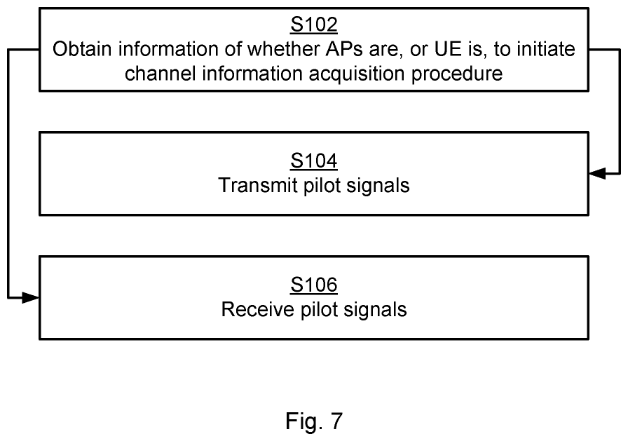

Reference is now made to FIG. 7 illustrating a method for initiating a channel information acquisition procedure in a D-MIMO network 100 as performed by the UE 300 according to an embodiment. The channel information acquisition procedure is initiated by transmission of pilot signals in the D-MIMO network 100. The D-MIMO network 100 comprises APs 110 serving UEs 300.
S202: The UE 300 obtains, from the centralized node 200 in the D-MIMO network 100, information of whether the channel information acquisition procedure is to be initiated in downlink or uplink.
S204: The UE 300 transmits the pilot signals when the channel information acquisition procedure is to be initiated on the uplink.
S206: The UE 300 receives the pilot signals from at least some of the APs 110 when the channel information acquisition procedure is to be initiated on the downlink.

Embodiments relating to further details of initiating a channel information acquisition procedure in a D-MIMO network 100 as performed by the UE 300 will now be disclosed.

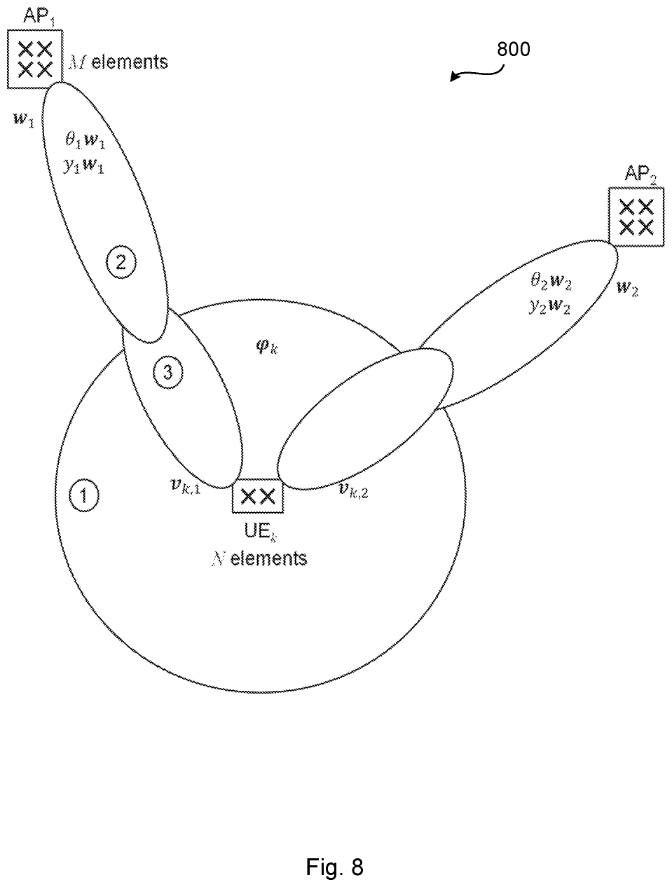

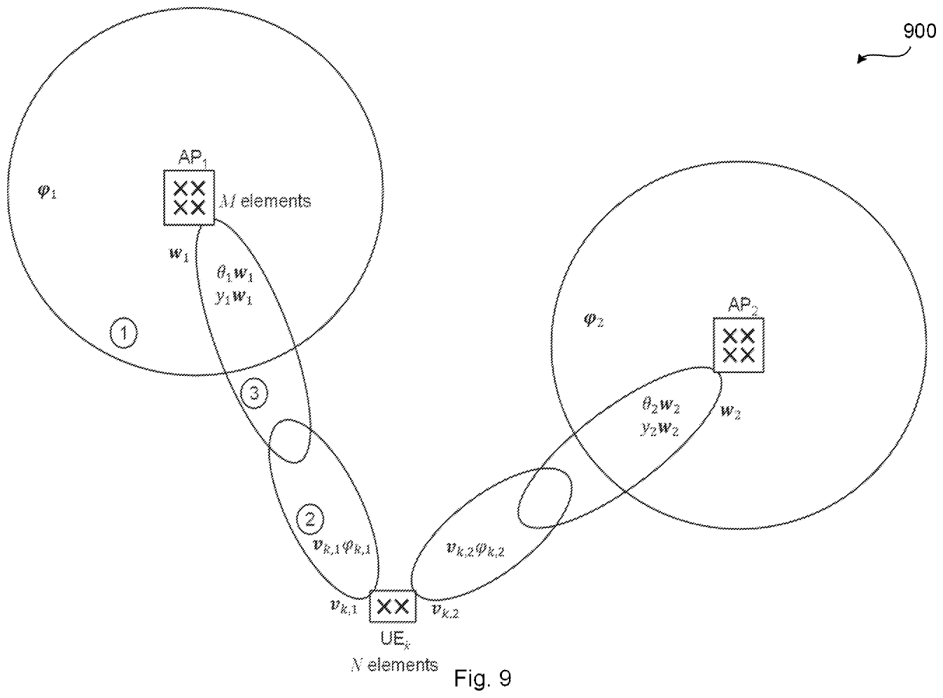

FIG. 8 represents a scenario 800 where the channel information acquisition procedure is initiated by the UEs 300, as in FIG. 9 represented by UEₖ. In FIG. 8 the following notation is used. The channel between UEₖ and APₗ is denoted G_{k,l}. The beamformer for APₗ is denoted wₗ=[w_{l,1} . . . w_{l,M}]^{T}. The downlink pilot signal as transmitted by APₗ is denoted θₗ. The downlink pilot signal as transmitted by APₗ is denoted yₗ. The uplink pilot signal as transmitted by UEₖ is denoted φₖ=[φ_{k,l} . . . φ_{k,N}]^{T}. The beamformer as used by UEₖ towards APₗ is denoted v_{k,l}=[φ_{k,l,1} . . . φ_{k,l,N}]^{T}. The signal received by UEₖ from APₗ is denoted u_{k,l}=yₗwₗG_{k,l}v_{k,l}+nₖ, where nₖ is channel noise. Actions represented by the encircled numbers 1, 2, 3 in FIG. 8 will be disclosed next.
1: UEₖ first transmits a pilot signal denoted by φₖ. The APs 110, as in FIG. 8 represented by AP₁ and AP₂, receive the uplink pilot signal φₖ and use it to obtain channel information. With the channel information, AP₁ and AP₂ can determine a vector of transmit beamforming weights denoted w₁ and w₂, respectively.
2: Using the transmit beamforming weights w₁, AP₁ can transmit a downlink data signal, in FIG. 8 represented by a scalar y₁, as w₁y₁. In addition, AP₁ may transmit a downlink pilot signal, in FIG. 8 represented by the scalar θ₁, as w₁θ₁. Similarly, AP₂ can transmit a beamformed data signal w₂y₂ and a beamformed downlink pilot signal w₂θ₂.
3: UEₖ may use the received beamformed downlink pilot signals w₁θ₁ and w₂θ₂ to obtain receiver side CSI for determining a set of receive antenna combining weight vectors v₁ and v₂.

It is assumed here that the UE (and the APs) has beam correspondence capabilities, in the sense that it either is 1) able to obtain a suitable direction to steer a transmit beam from DL reference signals, or it is 2) able to obtain full UL channel information (e.g., amplitude and phase for all subcarriers, or physical resource blocks (PRBs) for all beams, and/or antennas) and thus steer a transmit beam accordingly, from DL reference signals.

FIG. 9 represents a scenario 900 where the channel information acquisition procedure is initiated by the APs 110, as in FIG. 9 represented by AP₁ and AP₂. In FIG. 9 the following notation is used. The channel between UEₖ and APₗ is denoted G_{k,l}. The beamformer for APₗ is denoted wₗ=[w_{l,1} . . . w_{l,M}]^{T}. The downlink pilot signal as transmitted by APₗ is denoted θₗ. The downlink data signal as transmitted by APₗ is denoted yₗ. The uplink pilot signal as transmitted by UEₖ is denoted φₖ=[φ_{k,1} . . . φ_{k,N}]^{T}. The beamformer as used by UEₖ towards APₗ is denoted v_{k,l}=[φ_{k,l,1} . . . φ_{k,l,N}]^{T}. The signal received by UEₖ from APₗ is denoted u_{k,l}=yₗwₗG_{k,l}v_{k,l}+nₖ, where nₖ is channel noise. Actions represented by the encircled numbers 1, 2, 3 in FIG. 9 will be disclosed next.
1: AP₁ and AP₂ each transmits a pilot signal denoted φ₁ and φ₂, respectively.
2: UEₖ receives these downlink pilot signals φₖ, k=1, 2 and uses them to obtain channel information. With the channel information, UEₖ can determine a vector of beamforming weights targeting AP₁ and AP₂, denoted v_{k,1} and v_{k,2}, respectively. Using the weights v_{k,1} and v_{k,2} UEₖ can transmit uplink pilot signals φ_{k,1} as v_{k,1}φ_{k,1} and φ_{k,2} as v_{k,2}φ_{k,2}.
3: AP₁ and AP₂ may then obtain channel information based on the reception of φ_{k,1} and φ_{k,2}. The channel information can by the APs be used to determine beamforming vectors w₁ and w₂ that are then used to transmit downlink data signals y₁ and y₂ and possibly together with downlink pilots θ₁ and θ₂ within the narrow beams defined by w₁ and w₂.

FIG. 8 and FIG. 9 both represent examples where there is a need to transmit data in the downlink. Constructing similar examples for the case when there is a need to transmit uplink data is straightforward.

A channel information acquisition procedure as initiated by one of the UEs will be disclosed next with reference next to the signalling diagram of FIG. 10.
S301: The centralized node (Cent.) performs steps S102-S106 of FIG. 3.
S302: It is here assumed that the UE based utility score is highest. Thus, the centralized node decides that the channel information acquisition procedure is to be initiated from the UE side.
S303a: The controller entity informs the UE to initiate the channel information acquisition procedure, as in step S108, and provides pilot signal configuration to the serving APs.
S303b: The APs forward the pilot signal configuration to the UE.

It is here noted that in some examples the UE is not explicitly informed about the pilot signal configuration and step S305b is therefore optional. In one alternative, the absence of an expected downlink pilot signal transmission is used to implicitly instruct the UE to initiate the channel information acquisition procedure. In one alternative, a default time window is assigned for uplink pilot signal transmissions. In one alternative, the pilot signal configuration is pre-configured (e.g. during a previously active mode transmission) in the UE.
S304: The UE obtains the downlink control information (explicitly or implicitly).
S305: The UE initiates the channel information acquisition procedure by transmitting a pilot signal.
S306: The APs receive the pilot signal from the UE, obtain channel information, and determine antenna weights for performing further narrow beam transmissions and receptions (data channels, reference signals, control channels, etc.) related to the UE.
S307: The APs perform precoded downlink transmission, possibly including both pilot signals and data, in accordance with the determined antenna weights.
S308: The UE, from the precoded downlink transmission, obtains required channel information and determines transmission and receive antenna weights for transmitting and receiving data related to the serving APs, and possibly also the data itself.
S308: The UE performs precoded uplink transmission in accordance with the determined antenna weights.

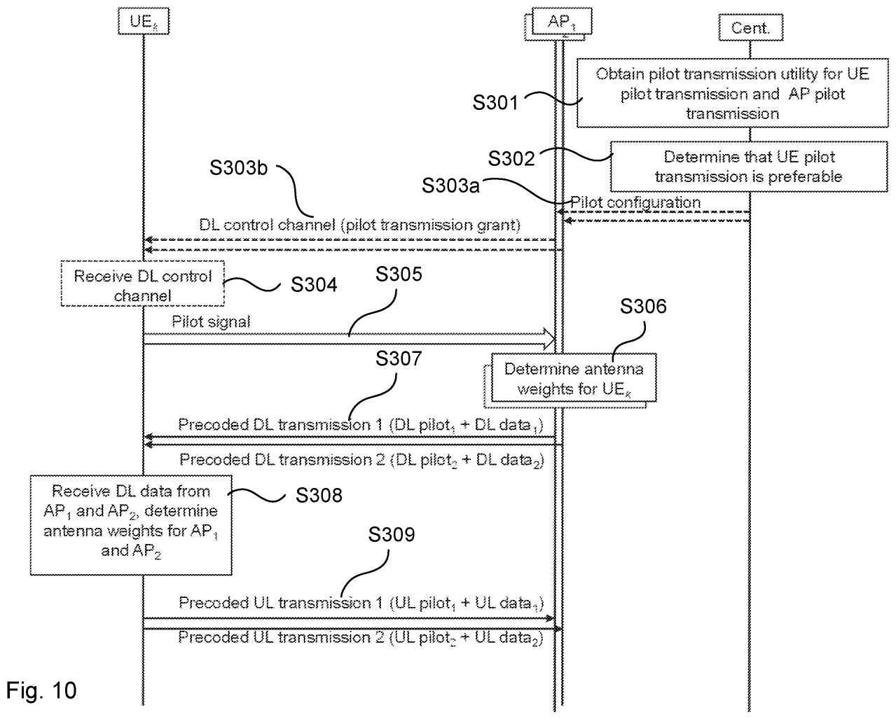

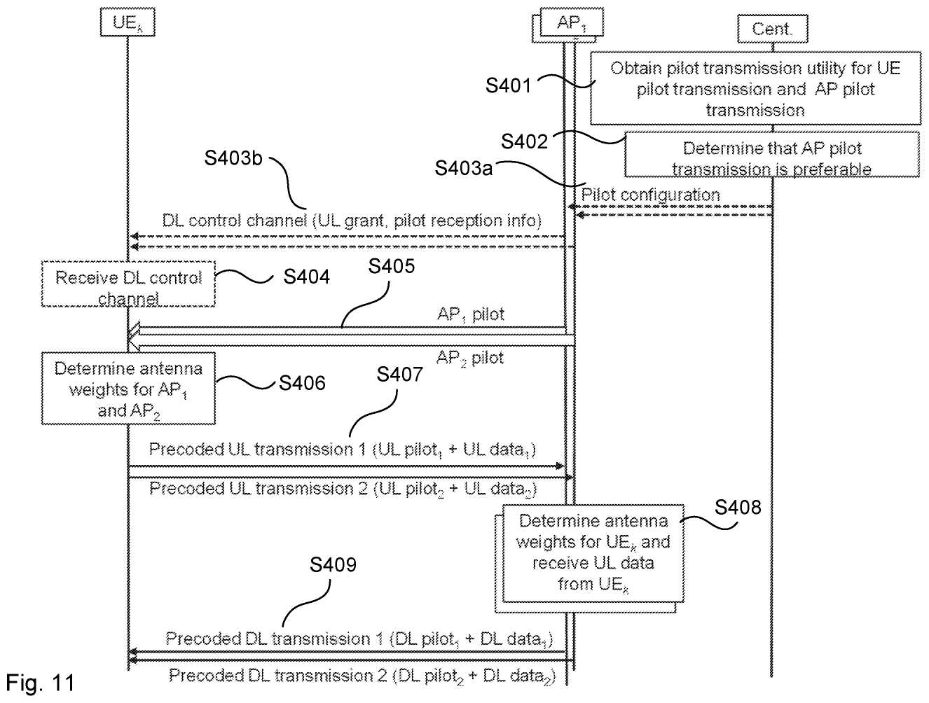

A channel information acquisition procedure as initiated by the APs will be disclosed next with reference next to the signalling diagram of FIG. 11.
S401: The centralized node (Cent.) performs steps S102-S106 of FIG. 3.
S402: It is here assumed that the AP based utility score is highest. Thus, the centralized node decides that the channel information acquisition procedure is to be initiated from the AP side.
S403a: The controller entity informs the APs to initiate the channel information acquisition procedure, as in step S108, and provides pilot signal configuration to the serving APs.
S403b: The APs transmits control information (UL grants, pilot signal reception information, etc.) to the UE.
S404: The UE receives the control information.

It is here noted that in some examples the UE is not explicitly informed about the pilot signal reception information and this information in step S403b is therefore optional. In one alternative, a default time window is assigned for downlink pilot signal transmissions. In one alternative, the control information is pre-configured (e.g. during a previously active mode transmission) in the UE.
S405: The APs initiate the channel information acquisition procedure by transmitting a pilot signal.
S406: The UE receives the pilot signal from the APs, obtains channel information, and determine antenna weights for performing further narrow beam transmissions and receptions (data channels, reference signals, control channels, etc.) related to the APs.
S407: The UE performs precoded uplink transmission, possibly including both pilot signals and data, in accordance with the determined antenna weights.
S408: The APs, from the precoded uplink transmission, obtain required channel information and determines transmission and receive antenna weights for transmitting and receiving data related to the UE, and possibly also the data itself.
S409: The APs perform precoded downlink transmission in accordance with the determined antenna weights.

To quantify some of the advantages of the herein disclosed embodiments, the total overhead cost for reference signal transmissions needed for channel information acquisition in a downlink data transmission scenario will be considered. A scenario is assumed with 10 APs, each having 8 antenna elements, and 20 active UEs, each having 4 antenna elements. The total number of antenna ports on the AP side is then 10×8=80 and the total number of antenna ports on the UE side is 20×4=80.

The pilot signal transmission overhead cost can be measured in the total number of antenna ports that needs to be observed. For example, if there are 8 antenna points at a given AP, then this given AP could create 8 orthogonal narrow beams which together would constitute a wide beam. In this example the cost of transmitting pilot signals from the APs and the cost of transmitting pilot signals from the UEs is the same; 80 pilot signals are required for each.

Since this example considers downlink transmission of data, no additional transmission of pilot signals is required if the UEs initiate the channel information acquisition procedure case (as in example C in FIG. 6). The channel information from the UE initiated channel information acquisition procedure end up at the transmitter side which in this case is in the APs. The total number of pilot signals for the UE initiated channel information acquisition procedure is therefore 80.

For the AP initiated channel information acquisition procedure, the channel information from the channel information acquisition procedure is first obtained on the UE side. Another set of 20 pilot signal transmissions (one per UE) is required for the transmitter side to obtain the required channel information (as in example D of FIG. 6). The total number of pilot signal transmissions in this case is 80 (in the DL)+20 (in the UL)=100 (in total).

In this example, there is thus a small overhead advantage with using a UE initiated channel information acquisition procedure.

However, the number of active UEs dynamically change on a TTI time scale, and there will in a real system not be a constant number of 20 active UEs all the time. In Table 1 below is summarized how the total overhead cost in terms of pilot signal transmissions for the case with a scenario as described above with 20 active UEs (denoted baseline), the case where 2 UEs are active in the same TTI (denoted Case 1), and the case where 40 UEs are active in the same TTI (denoted Case 2).

As can be observed, the difference between the alternatives (UE initiated channel information acquisition procedure versus AP initiated channel information acquisition procedure) can in some cases be very large (more than 10 times for Case 1).

TABLE 1
Total number of pilot signals required for channel information
acquisition for downlink data transmission.

| | Baseline | Case 1: | Case 2: |
|---|---|---|---|
| | (20 active UEs) | (2 active UEs) | 40 active UEs |
| UE | 20 × 4 = 80 | 2 × 4 = 8 | 40 × 4 = 160 |
| initiated | | | |
| AP | 10 × 8 + 20 = 100 | 10 × 8 + 2 = 82 | 10 × 8 + 40 = 120 |
| initiated | | | |

A similar comparison can be made for the case with UL data transmission. The data transmission delay may also impact the preferred selection of channel information acquisition procedure. Also, in a real system not all UEs will have 4 antenna elements. Some may have e.g., 8 antenna elements and other UEs may have e.g., just one single antenna element. In a realistic scenario there will be a mix of UEs with different number of antenna elements. It is, however, clear from the example illustrated in Table 1 that neither a fixed AP initiated channel information acquisition procedure, nor a fixed UE initiated channel information acquisition procedure can be the optimal choice in all the different scenarios under consideration.

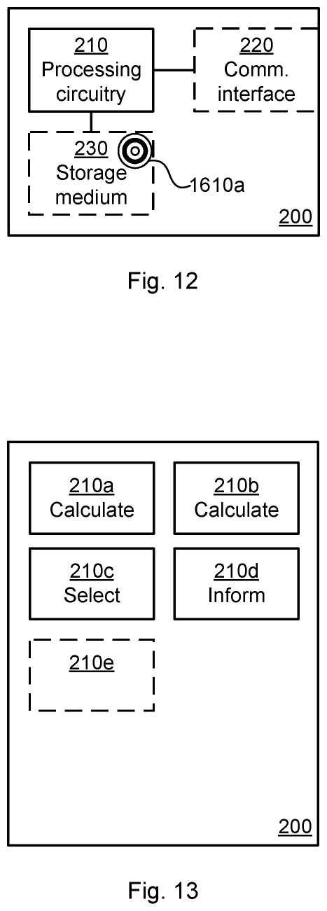

FIG. 12 schematically illustrates, in terms of a number of functional units, the components of a centralized node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1610a (as in FIG. 16), e.g., in the form of a storage medium 230. The processing circuitry 210 may further be provided as at least one application specific integrated circuit (ASIC), or field programmable gate array (FPGA).

Particularly, the processing circuitry 210 is configured to cause the centralized node 200 to perform a set of operations, or steps, as disclosed above. For example, the storage medium 230 may store the set of operations, and the processing circuitry 210 may be configured to retrieve the set of operations from the storage medium 230 to cause the centralized node 200 to perform the set of operations. The set of operations may be provided as a set of executable instructions. Thus, the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The centralized node 200 may further comprise a communications interface 220 for communications with APs 110, as in FIG. 2. As such the communications interface 220 may comprise one or more transmitters and receivers, comprising analogue and digital components.

The processing circuitry 210 controls the general operation of the centralized node 200 e.g., by sending data and control signals to the communications interface 220 and the storage medium 230, by receiving data and reports from the communications interface 220, and by retrieving data and instructions from the storage medium 230. Other components, as well as the related functionality, of the centralized node 200 are omitted in order not to obscure the concepts presented herein.

FIG. 13 schematically illustrates, in terms of a number of functional modules, the components of a centralized node 200 according to an embodiment. The centralized node 200 of FIG. 13 comprises a number of functional modules; a calculate module 210a configured to perform step S102, a calculate module 210b configured to perform step S104, a select module 210c configured to perform step S106, and an inform module 210d configured to perform step S108. The centralized node 200 of FIG. 13 may further comprise a number of optional functional modules, as represented by functional module 210e. In general terms, each functional module 210a:210e may be implemented in hardware or in software. Preferably, one or more or all functional modules 210a:210e may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210e and to execute these instructions, thereby performing any steps of the centralized node 200 as disclosed herein.

The centralized node 200 may be provided as a standalone device or as a part of at least one further device. For example, the centralized node 200 may be provided in a node of a (radio) access network or in a node of a core network. Alternatively, functionality of the centralized node 200 may be distributed between at least two devices, or nodes. These at least two nodes, or devices, may either be part of the same network part (such as the (radio) access network or the core network) or may be spread between at least two such network parts. In general terms, instructions that are required to be performed in real time may be performed in a device, or node, operatively closer to the cells than instructions that are not required to be performed in real time. Thus, a first portion of the instructions performed by the centralized node 200 may be executed in a first device, and a second portion of the instructions performed by the centralized node 200 may be executed in a second device; the herein disclosed embodiments are not limited to any particular number of devices on which the instructions performed by the centralized node 200 may be executed. Hence, the methods according to the herein disclosed embodiments are suitable to be performed by a centralized node 200 residing in a cloud computational environment. Therefore, although a single processing circuitry 210 is illustrated in FIGS. 12, the processing circuitry 210 may be distributed among a plurality of devices, or nodes. The same applies to the functional modules 210a:210e of FIG. 13 and the computer program 1620a of FIG. 16.

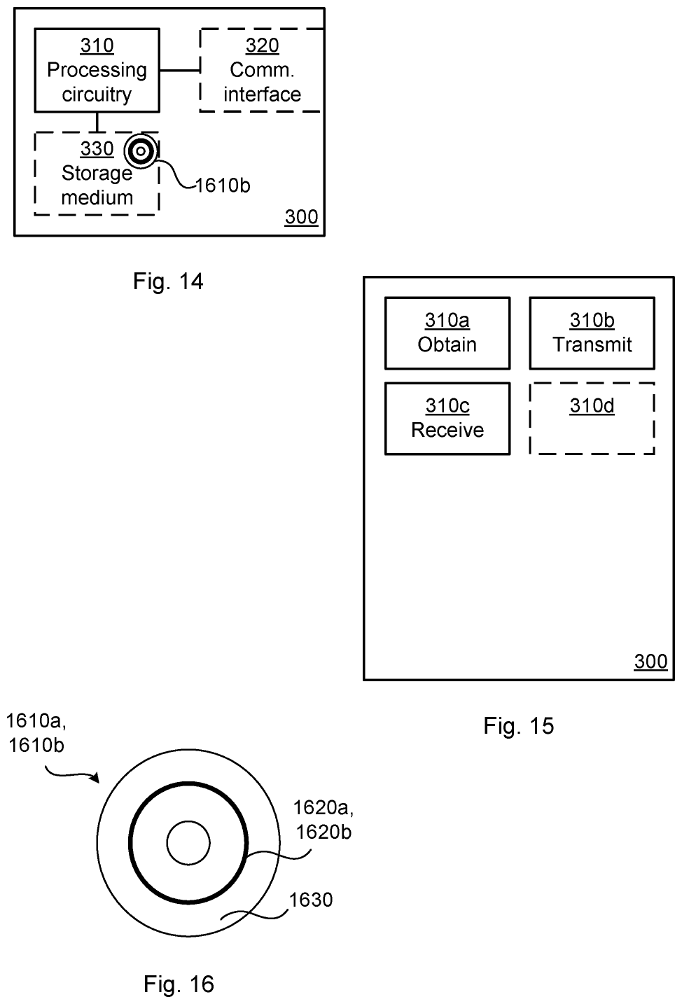

FIG. 14 schematically illustrates, in terms of a number of functional units, the components of a UE 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1610b (as in FIG. 16), e.g. in the form of a storage medium 330. The processing circuitry 310 may further be provided as at least one application specific integrated circuit (ASIC), or field programmable gate array (FPGA).

Particularly, the processing circuitry 310 is configured to cause the UE 300 to perform a set of operations, or steps, as disclosed above. For example, the storage medium 330 may store the set of operations, and the processing circuitry 310 may be configured to retrieve the set of operations from the storage medium 330 to cause the UE 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The UE 300 may further comprise a communications interface 320 for communications with APs 110, as in FIG. 2. As such the communications interface 320 may comprise one or more transmitters and receivers, comprising analogue and digital components.

The processing circuitry 310 controls the general operation of the UE 300 e.g. by sending data and control signals to the communications interface 320 and the storage medium 330, by receiving data and reports from the communications interface 320, and by retrieving data and instructions from the storage medium 330. Other components, as well as the related functionality, of the UE 300 are omitted in order not to obscure the concepts presented herein.

FIG. 15 schematically illustrates, in terms of a number of functional modules, the components of a UE 300 according to an embodiment. The UE 300 of FIG. 15 comprises a number of functional modules; an obtain module 310a configured to perform step S202, a transmit module 310b configured to perform step S204, and a receive module 310c configured to perform step S206. The UE 300 of FIG. 15 may further comprise a number of optional functional modules, as represented by functional module 310d. In general terms, each functional module 310a:310d may be implemented in hardware or in software. Preferably, one or more or all functional modules 310a:310d may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310d and to execute these instructions, thereby performing any steps of the UE 300 as disclosed herein.

FIG. 16 shows one example of a computer program product 1610a, 1610b comprising computer readable means 1630. On this computer readable means 1630, a computer program 1620a can be stored, which computer program 1620a can cause the processing circuitry 210 and thereto operatively coupled entities and devices, such as the communications interface 220 and the storage medium 230, to execute methods according to embodiments described herein. The computer program 1620a and/or computer program product 1610a may thus provide means for performing any steps of the centralized node 200 as herein disclosed. On this computer readable means 1630, a computer program 1620b can be stored, which computer program 1620b can cause the processing circuitry 310 and thereto operatively coupled entities and devices, such as the communications interface 320 and the storage medium 330, to execute methods according to embodiments described herein. The computer program 1620b and/or computer program product 1610b may thus provide means for performing any steps of the UE 300 as herein disclosed.

In the example of FIG. 16, the computer program product 1610a, 1610b is illustrated as an optical disc, such as a CD (compact disc) or a DVD (digital versatile disc) or a Blu-Ray disc. The computer program product 1610a, 1610b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1620a, 1620b is here schematically shown as a track on the depicted optical disk, the computer program 1620a, 1620b can be stored in any way which is suitable for the computer program product 1610a, 1610b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for initiating a channel information acquisition procedure in a distributed multiple input multiple output (D-MIMO) network, the channel information acquisition procedure being initiated by transmission of pilot signals in the D-MIMO network, the D-MIMO network comprising access points (AP) serving user equipments (UEs), the method being performed by a centralized node in the D-MIMO network, the method comprising:
calculating an AP based utility score for the APs to initiate the channel information acquisition procedure, wherein the AP based utility score pertains to an estimated network improvement and an estimated network resource cost if the channel information acquisition procedure is initiated by the APs;
calculating a UE based utility score for the UEs to initiate the channel information acquisition procedure, wherein the UE based utility score pertains to an estimated network improvement and an estimated network resource cost if the channel information acquisition procedure is initiated by the UEs;
selecting, for initiating the channel information acquisition procedure, the APs when the AP based utility score is highest, and the UEs when the UE based utility score is highest; and
informing the APs and the UEs of which of the APs and the UEs to initiate the channel information acquisition procedure.

2. The method of claim 1, wherein the estimated network resource cost for the AP based utility score is dependent on amount of radio resources required for transmitting the pilot signals from the APs.

3. The method of claim 1, wherein the estimated network resource cost for the UE based utility score is dependent on amount of radio resources required for transmitting the pilot signals from the UEs.

4. The method of claim 1, wherein the network improvement for the AP based utility score is proportional to number of active UEs being served per each of the APs as averaged over a number of transmission time intervals, TTIs.

5. The method of claim 1, wherein the network improvement for the UE based utility score is proportional to number of APs serving each of the active UEs as averaged over a number of transmission time intervals, TTIs.

6. The method of claim 1, wherein the network improvement for the AP based utility score is proportional to a total number of active UEs being served by any of the APs.

7. The method of claim 1, wherein the estimated network resource cost for the UE based utility score is proportional to a total number of APs serving any active UEs.

8. The method of claim 1, wherein the network improvement for the AP based utility score is proportional to, and the network improvement for the UE based utility score is inversely proportional to, expected or ongoing amount of uplink data traffic.

9. The method of claim 1, wherein the network improvement for the UE based utility score is proportional to, and the network improvement for the AP based utility score is inversely proportional to, expected or ongoing amount of downlink data traffic.

10. The method of claim 1, wherein the network improvement for the AP based utility score is proportional to, and the network improvement for the UE based utility score is inversely proportional to a delay requirement for uplink data traffic.

11. The method of claim 1, wherein the network improvement for the UE based utility score is proportional to, and the network improvement for the AP based utility score is inversely proportional to a delay requirement for downlink data traffic.

12. The method of claim 1, wherein the network improvement for the AP based utility score is inversely proportional to an expected data transmission delay for uplink and/or downlink data transmission if the channel information acquisition procedure is initiated for the APs, and the network improvement for the UE based utility score is inversely proportional to an expected data transmission delay for uplink and/or downlink data transmission if the channel information acquisition procedure is initiated for the UEs.

13. The method of claim 1, wherein the network improvement for the AP based utility score is inversely proportional to a time duration for setting up the channel information acquisition procedure as initiated for the APs, and the network improvement for the UE based utility score is inversely proportional to a time duration for setting up the channel information acquisition procedure as initiated for the UEs.

14. A method for initiating a channel information acquisition procedure in a distributed multiple input multiple output (D-MIMO) network, the channel information acquisition procedure being initiated by transmission of pilot signals in the D-MIMO network, the D-MIMO network comprising access points (APs) serving user equipments (UEs), the method being performed by one of the UEs, the method comprising:
obtaining, from a centralized node in the D-MIMO network, information of whether the channel information acquisition procedure is to be initiated in downlink or uplink;
transmitting the pilot signals when the channel information acquisition procedure is to be initiated on the uplink; and
receiving the pilot signals from at least some of the APs when the channel information acquisition procedure is to be initiated on the downlink.

15. The method of claim 14, wherein the pilot signals as transmitted by the APs are service area covering downlink reference signals.

16. The method of claim 14, wherein the pilot signals as transmitted by the UEs are uplink reference signals.

17. A centralized node for initiating a channel information acquisition procedure in a distributed multiple input multiple output (D-MIMO) network, the channel information acquisition procedure being initiated by transmission of pilot signals in the D-MIMO network, the D-MIMO network comprising access points (APs) serving user equipments (UEs), the centralized node comprising processing circuitry, the processing circuitry being configured to cause the centralized node to:
calculate an AP based utility score for the APs to initiate the channel information acquisition procedure, wherein the AP based utility score pertains to an estimated network improvement and an estimated network resource cost if the channel information acquisition procedure is initiated by the APs;
calculate a UE based utility score for the UEs to initiate the channel information acquisition procedure, wherein the UE based utility score pertains to an estimated network improvement and an estimated network resource cost if the channel information acquisition procedure is initiated by the UEs;
select, for initiating the channel information acquisition procedure, the APs when the AP based utility score is highest, and the UEs when the UE based utility score is highest; and
inform the APs and the UEs of which of the APs and the UEs to initiate the channel information acquisition procedure.

18-19. (canceled)

20. A user equipment (UE) for initiating a channel information acquisition procedure in a distributed multiple input multiple output (D-MIMO) network, the channel information acquisition procedure being initiated by transmission of pilot signals in the D-MIMO network, the D-MIMO network comprising access points, APs, serving UEs, the UE comprising processing circuitry, the processing circuitry being configured to cause the UE to:
obtain, from a centralized node in the D-MIMO network, information of whether the channel information acquisition procedure is to be initiated in downlink or uplink;
transmit the pilot signals when the channel information acquisition procedure is to be initiated on the uplink; and
receive the pilot signals from at least some of the APs when the channel information acquisition procedure is to be initiated on the downlink.

21-25. (canceled)

26. A non-transitory computer readable storage medium storing a computer program for configuring a centralized node comprising processing circuitry for executing the computer program to perform the method of claim 1.

27. A non-transitory computer readable storage medium storing a computer program for configuring a user equipment comprising processing circuitry for executing the computer program to perform the method of claim 14.
